(19) United States
(12) Patent Application Publication
(10) Pub. No.: US 2010/0169176 A1
(43) Pub. Date: Jul. 1, 2010

(54) METHOD FOR TRACKING USER BEHAVIOR AND TO DISPLAY ADVERTISEMENTS

(76) Inventor: Bhavin Turakhia, Mumbai (IN)

Correspondence Address: Husch Blackwell Sanders, LLP;Husch Blackwell Sanders LLP Welsh & Katz, 120 S RIVERSIDE PLAZA, 22ND FLOOR, CHICAGO, IL, 60606, US

(21) Appl. No.: 12/443,617

(22) PCT Filed: Sep. 13, 2007
(86) PCT No.: PCT/IN07/00419

§ 371 Date: Mar. 30, 2009

(30) Foreign Application Priority Data
Sep. 14, 2006 (IN) 1462/MUM/2006

(51) Int. Cl. G06Q 30/00; G06F 15/16

(52) U.S. Cl. 705/14.52; 705/14.53; 705/14.54; 709/203

(57) ABSTRACT

The present invention relates generally to a method and system for displaying advertisements on a client computing device and specifically to a method and system for analyzing user behavior and targeting advertisements based on the user behavior.

### FIELD OF INVENTION

The present invention relates generally to a method and system for displaying advertisements on a client computing device and specifically to a method and system for analyzing user behavior and targeting advertisements based on the user behavior.

### BACKGROUND OF THE INVENTION

Various Internet services nowadays are provided free, with the revenue model being, building an audience and selling advertisement and using the revenue generated from the advertisement to finance their costs. Due to the increase in the amount of time each user spends on a computer, delivering targeted user behavior based commercial content has proved to be extremely useful and profitable. Display of user behavior based commercial content increases the likelihood of a user getting commercial content exactly based on his requirements leading to higher conversions for the advertiser.

Hence, there is a need to provide a method and system for delivering user behavior based commercial content directly in client applications.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of an embodiment of the present invention.

FIG. 2 illustrates a flow diagram of the behavior tracker 110 pursuant to an embodiment of the present invention.

FIG. 3 illustrates a flow diagram of the method of displaying advertisements based on user behavior information pursuant to an embodiment of the present invention.

### DETAILED DESCRIPTION OF THE INVENTION

Before describing in detail embodiments that are in accordance with the invention, it should be observed that the embodiments reside primarily in combinations of method steps and apparatus components related to tracking user behavior and displaying advertisements. Accordingly, the system components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional processors and unique stored program instructions that control the one or more processors to implement, in conjunction with certain non-processor circuits, some, most, or all of the functions of inserting and removing advertisements described herein. The non-processor circuits may include, but are not limited to, a radio receiver, a radio transmitter, signal drivers, clock circuits, power source circuits, and user input devices. As such, these functions may be interpreted as steps of a method for tracking user behavior and displaying advertisements. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

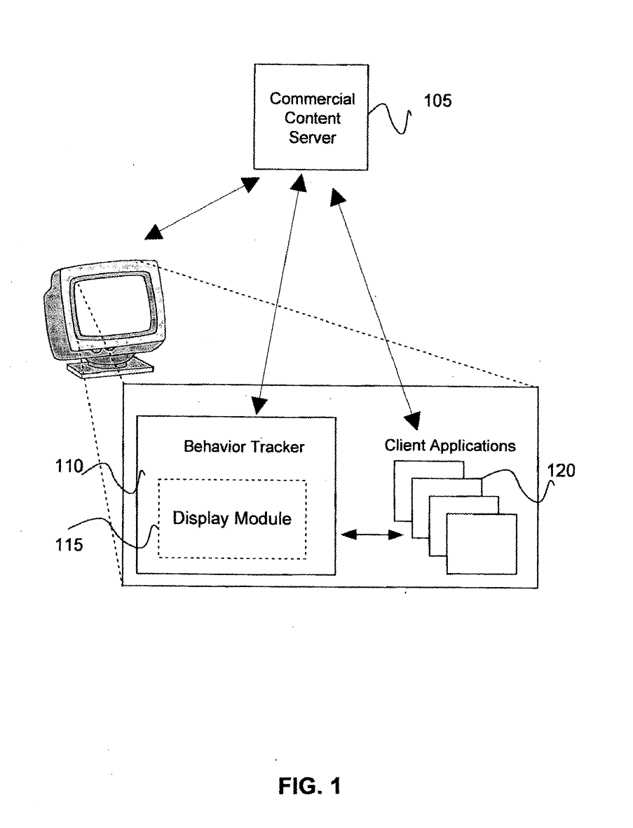

Referring now to FIG. 1 illustrates a block diagram of an embodiment of the present invention. As technology progresses, a greater number of users rely on computing systems for their daily needs. A client computing devices can be a laptop, a personal computer, a personal digital assistant or even a mobile phone. Users spend a substantial amount of time using such client computing devices and hence, targeting advertisements and commercial content based on their activity and interaction with the client computing devices may lead to greater sales.

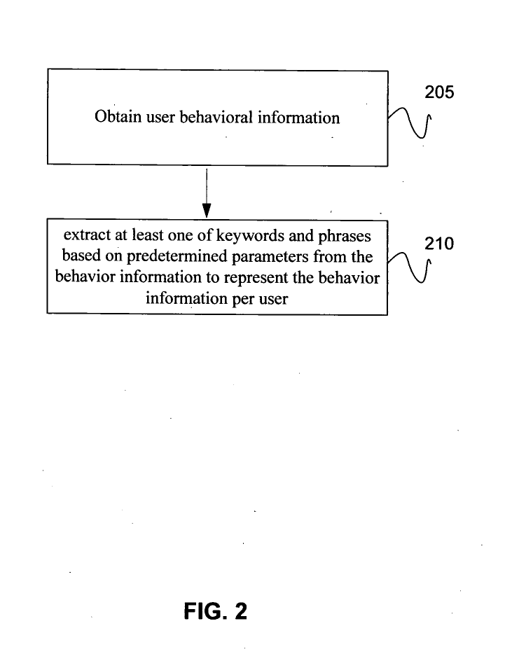

An embodiment of the present invention comprises a client computing system. The client computing system may comprise a behavior tracker 110 which is in communication with independent third party client applications installed on the client computing system. The client applications and the behavior tracker 110 may also be in communication with a commercial content server 105. The behavior tracker 110 is responsible for collecting user behavior information on a continuous basis and storing the user behavior information on the client computing system. The behavior tracker 110 determines various keywords and user attributes through monitoring the user behavior. In an alternate embodiment, the behavior tracker 110 may also send the user behavior information periodically to the commercial content server 105. Several third party client applications such as word processors, chat programs, email clients, browsers etc are installed on the client computing system by the user. These client applications wish to display relevant commercial content such as advertisements to a user. Such client applications can receive advertisements from the commercial content server 105 or even the behavior tracker 110 for display within the application. As per one embodiment, all user behavior information stored on the client computing system or sent to the commercial content server 105 is encrypted and hence not readable by the client applications or anyone else in order to protect user privacy. A display module 115 which can be part of at least one of the client application 120, the behavior tracker 110, the user operating system or any independent application can be responsible for displaying the commercial content either within the client application 120 or within an external panel of the client application 120. The detailed workings of the behavior tracker 110 are described using FIG. 2.

Referring now to FIG. 2 illustrates a flow diagram of the behavior tracker 110 pursuant to an embodiment of the present invention. The behavior tracker 110 can be software installed on the client computing system or may even reside on a remote server and be in contact communication with the client computing system. The behavior tracker 110 is responsible for obtaining user behavior information, Step 205 and extracting at least one of keywords and phrases based on predetermined parameters from the behavior information to represent the behavior information per user, Step 215. For example, the behavior tracker 110 may store behavioral information such as specifications of a client computing system, applications installed by a user of the client computing system, internet browsing history of each user, user document files, user email, use chat history, user music files, computer status messages and user demographics. The behavior tracker 110 may then be configured to extract at least one of keywords and phrases based on predetermined parameters from the behavior information to represent the behavior information per user. As per one embodiment, profiles of individual users can also be maintained to collect user behavior information pertaining to each user separately and to keep user behavior information of users protected from each other. Profiles can be used to target commercial content based on the behavior information of the profile currently active.

Further, the behavior tracker 110 may track the applications installed, used and approximate usage time of the application per user. For instance, a user using graphics applications such as Photoshop or Paintbrush may be an artist or a graphic designer and advertisements can be targeted based on usage of client application 120s. Keyloggers to log all text typed on the computing system may be installed and keywords can be extracted from the text to create user behavior information. Generally, the user's browsing history can be extremely beneficial for analyzing user behavior. The websites a user visits, the time spent on each website, the content downloaded by the user, and other content on that website, music, files etc can provide substantial user behavior information. As per one embodiment, the user behavior tracker 110 may also hook into a third party client application 120 to extract keywords and user attributes based on the content in the application. For instance, the behavior tracker 110 can hook into a word processor and obtain contents of the current document that the user is reading. As per another embodiment, the behavior tracker 110 can access and store all network data passing through the client device, such as email, web content, chat content. Based on all of the above user behavior information collected, the behavior tracker 110 can provide various attributes and keywords representative of the behavior information collected per user such as age, location, gender, topics/keywords he may be interested in. This information can be sent to the commercial content server 105. In one embodiment, each user's behavior information, keywords and attributes associated with the client computing device can be encrypted and stored on the client computing device. The encrypted current relevant user behavior information can be sent by the behavior tracker 110 to the client application 120 when it requests for the same which can then be forwarded to the commercial content server 105.

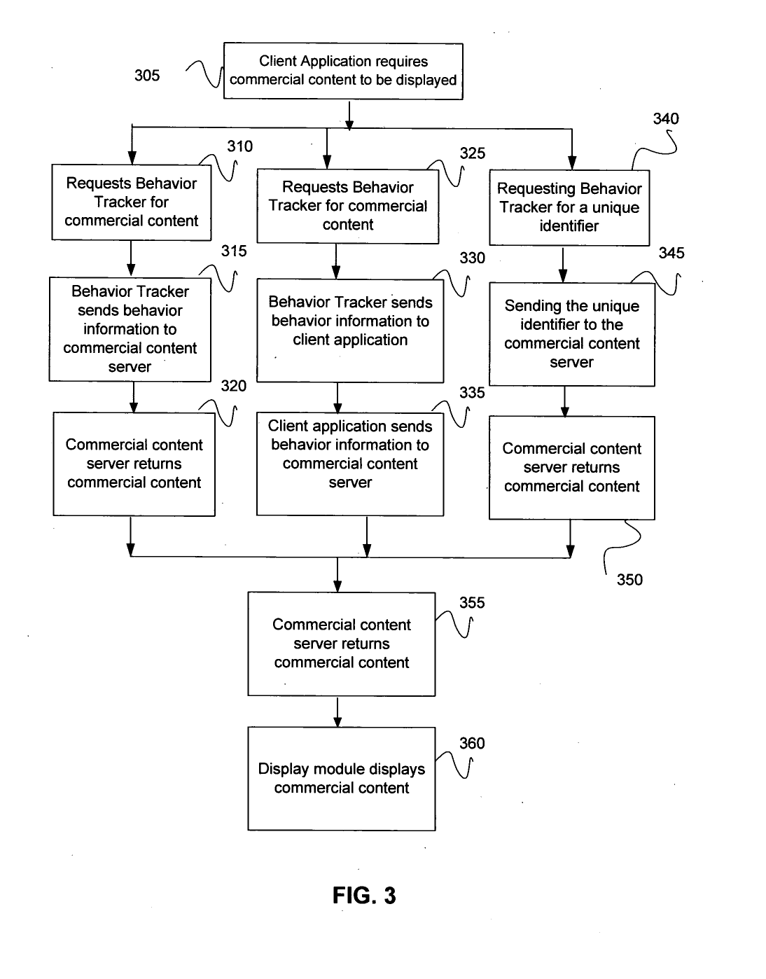

Turning now to FIG. 3, illustrates a flow diagram of the method of displaying advertisements based on user behavior information collected by the behavior tracker 110 pursuant to an embodiment of the present invention. Conventionally, when a client application 120, for example a word processor or an email client, wished to display advertisements or commercial content to a user within the application, the client application 120 did not have any information specific to the user to target such advertisements to the user. According to an embodiment of the present invention, the behavior tracker 110 described in FIG. 2 tracks user behavior and collect user behavior information. Based on the user behavior information, the behavior tracker 110 extracts/generates keywords, related concepts and user attributes representative of the behavior information.

Now, when the client application 120 wishes to display commercial content specific to user behavior, Step 305, the client application 120 can do so in a couple of ways. As per one embodiment, the client application 120 could contact the behavior tracker 110 to request for user behavior information, Step 310. However, the behavior tracker 110, in order to protect the privacy of the user, may send user behavior information in the form of the currently relevant keywords, related concepts or user attributes in an encrypted form. The behavior tracker 110 forwards the user behavior information in the encrypted form to a commercial content server 105, Step 320. The commercial content server 105 can be a remote server that receives advertisements and commercial content from advertisement networks or may even have a proprietary database of advertisements and commercial content provided by advertisers. The commercial content server 105 is able to decrypt the user behavior information since it understands the encryption algorithm applied by the behavior tracker 110. The advertisement receives the user behavior information, analyzes the keywords, related concepts, user attributes and sends advertisements and commercial content to the client application 120 for display, Step 320. The method of display has been described later.

As per an alternate embodiment, when a client application 120 wishes to display commercial content, the client application 120 may request the behavior tracker 110 for behavior information. Step 325. The client application 120 then forwards the behavior information to the commercial content server 105, Step 330. The commercial content server 105 analyzes the behavior information and returns commercial content targeted to the user. Those skilled in the art shall appreciate that the client application 120 may also be equipped to analyze the behavior information and extract keywords and phrases from the behavior information that is representative of the behavior information. The client application 120 may then send the representative information to the commercial content server 105. The commercial content server 105 may then return commercial content directly to the client application 120, Step 335. The behavior tracker 110, as per this embodiment, can be responsible for only collecting behavior information and sending the behavior information periodically to a client application 120.

As per another embodiment, the client application 120 may request the commercial content server 105 directly for commercial content and advertisements. As per this embodiment, the behavior tracker 110 on every client computing device is in constant communication with the commercial content server 105 and sends behavior information per user periodically to the commercial content server 105. In order to display advertisements and commercial content specific to the user, the commercial content server 105 and behavior tracker 110 may maintain a unique identifier of the user and stores behavior information per user against the corresponding user identifier. The unique identifier, for instance, can be the MAC address of the client computing system, or an IMIE number in case of a mobile phone, or even a behavior tracker 110 generated identifier. Now, when the client application 120 wishes to display commercial content, the client application 120 supplies this unique identifier directly or requests the behavior tracker 110 for the unique identifier and forwards the unique identifier to the commercial content server 105, Step 340 and Step 345. The commercial content server 105, which has already been in communication with the behavior tracker 110 to receive user behavior information per unique identifier, knows the current relevant keywords and user attributes as well as historical data it has accumulated. The commercial content server 105 then serves advertisements and commercial content to the client application 120 based on the user identifier, Step 350.

Further, the behavior tracker 110 may also have a profile manager which tracks different users of the client computing device either by their login name to the machine, or by behavior attributes, or by allowing a user to switch profiles using a password. Hence, if multiple users are using the same client computing device, advertisements can be targeted based on the user profile currently active. Privacy of users is also protected since user behavior of one user may not be accessible by another user. The profile manager may also allow the user to specify certain preferences and attributes such as age, sex, occupation to provide more accurate advertisements. Further, the behavior tracker 110 may also modify the body or header of the content passing through the device, through its network connection, in order to insert relevant advertisements, keywords and user attributes. As per one embodiment, the client application 120 may ask the display module 115, behavior tracker 110 or commercial content for a specific type of advertisement with details such as size, type etc. The client application 120 may also pass additional user attributes and current content that the user is looking at within the client application 120.

However there can be some privacy concerns when the client application 120 requests for the advertisements. Based on the advertisements served by the commercial content server 105, the client application 120 may be able to analyze the concepts based on which the commercial content server 105 generated the advertisements. The client application 120 can then determine user behavior information. To alleviate some of these privacy concerns, the client application 120 may only be provided graphical advertisements. All text based advertisements may also be converted to an image format. Displaying image based advertisements may prove difficult for the client application 120 to analyze the context of the advertisement and obtain user behavior information over a period of time. Another method can be that the client application 120 does not request the advertisements. Instead, the behavior tracker 110, which may generally be installed on the client computing device, may comprise an internal display module 115. The display module 115 may be responsible for creating a panel on the display screen of the client computing device based on, for instance, location on the display screen, size of the panel and then correspondingly display advertisements in that panel to display the commercial content, Step 360. The display properties of the panel are specified by the client application 120. However, the display module 115 can be responsible for controlling and managing the panels. Every request to change the display properties of the panel can be sent by the client application 120 to the display module 115. Now, the client application 120 will not receive the advertisements and hence, any concerns regarding user privacy may be alleviated. Alternatively the panel maybe directly controlled by the client application 120, but the display within the panel maybe delegated to the behavior tracker 110

Further, whether advertisements are displayed in the client application 120 or in a separate panel, the client application 120 may be permitted to specify additional parameters to the behavior tracker 110 for controlling the type of advertisements displayed. For instance, the client application 120 may prohibit display of adult advertisements or the number of advertisements can be restricted per user or the client application 120 may also specify which user behavior information attributes to not consider while displaying advertisements. For instance, application behavior of users may not be considered. Hence, an embodiment of the preset invention permits third party client application 120s to target advertisements and commercial content to users based on user behavior without comprising on user privacy. Displaying targeted advertisements on the desktop of the user shall increase advertiser visibility and sale while providing users with the ability to obtain more meaningful advertisements based on their needs.

The above mentioned advantages are merely exemplary and should not be restricted to the ones specified. Those skilled in the art shall appreciate that the advantages may be several and all such advantages are within the scope of the present invention.

What is claimed is:

1. A system for displaying user behavior based commercial content on a client computing system, the system comprising
a behavior tracker installed on the client computing system for collecting a behavioral information pertaining to a user;
a client application installed on the client computing system for requesting a display of commercial content from the behavior tracker based on the behavioral information;
a commercial content server for receiving a request for commercial content from the behavior tracker based on the behavioral information; and
a display module installed on the client computing system to display the commercial content.

2. The system of claim 1, wherein the behavioral information is at least one of specifications of a client computing system, applications installed by a user of the client computing system, internet browsing history of each user, user document files, user email, use chat history, user music files, computer status messages and user demographics.

3. The system of claim 2, wherein the behavior tracker is configured to extract at least one of keywords and phrases based on predetermined parameters from the behavioral information to represent the behavior information per user.

4. The system of claim 1, wherein the commercial content is displayed as at least one of within and alongside the content of the client application.

5. The system of claim 1, wherein the behavior tracker is a part of the client application.

6. The system of claim 1, wherein the behavior tracker is an independent module installed on a user computing system.

7. The system of claim 1, wherein the behavior tracker is configured to encrypt the behavioral information.

8. The system of claim 7, wherein the commercial content server is configured to decrypt the behavioral information.

9. The system of claim 1, wherein the behavior tracker is configured to send behavioral information periodically to the commercial content server.

10. The system of claim 1, wherein the display module can be part of at least one of the client application, the behavior tracker, operating system and any independent application.

11. A system for displaying user behavior based commercial content on a client computing system, the system comprising
a behavior tracker installed on the client computing system for collecting a behavioral information pertaining to a user;
a client application installed on the client computing system for requesting the behavioral information from the behavior tracker, the client application sending the behavioral information received from the behavior tracker to a commercial content server to request for commercial content;
a display module installed on the client computing system to display the commercial content received from the commercial content server.

12. The system of claim 11, wherein the behavioral information is at least one of specifications of a client computing system, applications installed by a user of the client computing system, internet browsing history of each user, content of user document files, content of user email, content of user chat history, user music files, computer status messages and user demographics.

13. The system of claim 11, wherein the behavior tracker is configured to encrypt the behavioral information.

14. The system of claim 12, wherein the behavior tracker is configured to extract at least one of keywords and phrases based on predetermined parameters from the behavioral information to represent the behavior information per user.

15. The system of claim 11, wherein the client application is configured to request for behavioral information periodically from the behavior tracker.

16. The system of claim 11, wherein different commercial content can be sent to different users of a computing system based on each user's behavioral information.

17. The system of claim 11, wherein the display module can be part of at least one of the client application, the behavior tracker, operating system and any independent application.

18. The system of claim 11, wherein the display module can display commercial content within an external panel.

19. The system of claim 11, wherein the commercial content is displayed within or alongside the content of the client application.

20. A system for displaying user behavior based commercial content on a client computing system, the system comprising:
a behavior tracker installed on the client computing system for collecting a behavioral information pertaining to a user;
a commercial content server for receiving the behavioral information from the behavior tracker, the commercial content server and behavior tracker storing a unique identifier per user;
a client application installed on the client computing system for obtaining the unique identifier from the behavior tracker and requesting for commercial content from the commercial content server based on the unique identifier; and
a display module installed on the client computing system to display the commercial content received from the commercial content server.

21. The system of claim 20, wherein each user is associated with a unique identifier enabling the commercial content server to send commercial content targeted to each user.

22. The system of claim 20, wherein the behavior tracker is configured to encrypt the behavioral information.

23. The system of claim 20, wherein the display module can be part of at least one of the client application, the behavior tracker, operating system and any independent application.

24. The system of claim 20, wherein the commercial content server is part of the behavior tracker.

25. The system of claim 20, wherein the commercial content is in a graphical form.

26. The system of claim 20, wherein the client application can specify predetermined parameters to the display module for displaying the commercial content.

27. A method for displaying user behavior based commercial content on a client computing system, the method comprising:
collecting a behavioral information pertaining to a user by a behavior tracker installed on the client computing system;
storing the behavioral information per user against a unique identifier;
receiving a request for obtaining commercial content at a commercial content server, based on at least one of the behavioral information and the unique identifier;
obtaining commercial content; and
displaying the commercial content alongside or within a client application

28. The method of claim 27, wherein the behavioral information is at least one of specifications of a client computing system, applications installed by a user of the client computing system, internet browsing history of each user, user document files, user email, use chat history, user music files, computer status messages and user demographics.

29. The method of claim 27, wherein the storing step comprises:
extracting at least one of keywords and phrases based on predetermined parameters from the behavior information to represent the behavior information per user.

30. The method of claim 27, wherein the commercial content is updated periodically on a dynamic basis.

31. The method of claim 27, wherein different commercial content can be sent to different users of a computing system based on a unique identifier associated with each user's behavioral information.

32. The method of claim 27, wherein the behavioral information is stored in an encrypted form.

33. The method of claim 27, wherein the commercial content can be displayed within an external panel associated with the client application.
